(19) United States
(12) Patent Application Publication
(10) Pub. No.: US 2003/0207606 A1
(43) Pub. Date: Nov. 6, 2003

(54) Locking and releasable electrical receptacle/connector

(76) Inventor: Su Yueh Ho, Flushing, NY (US)

Correspondence Address: Su Yueh Ho, 144-51 29 Ave., Flushing, NY, 11354, US

(21) Appl. No.: 10/441,362

(22) Filed: May 20, 2003

Related U.S. Application Data
(63) Continuation-in-part of application No. 09/681,209, filed on Feb. 22, 2001.

(51) Int. Cl. H01R 4/50

(52) U.S. Cl. 439/346

(57) ABSTRACT

An electrical receptacle/connector having a releasable locking portion for securing most standard electrical male plugs in part is disclosed. The said receptacle/connector having relative positioned jut elements which accept and restrain the holes near the ends of the contact blades of a male plug; the male plug insert action is the same as mating with a non locking receptacle/connector. A locking release button is used to disengage the said jut element portion which constructed within the receptacle/connector to release the contact blades of the male plug, therefore to free the contact blades from said invention.

### CROSS REFERENCE TO RELATED APPLICATIONS

This application is in continuation-in-part of application 09/681,209, which was filed on Feb. 22, 2001.

### BACKGROUND OF THE INVENTION

1. Field of the Invention

This invention relates to an electrical receptacle as wall outlet and or a female connector of one end of an electrical extension cord, more particularly to electrical receptacle/connector having releasable locking portion to secure the insert male plug in part.

2. Summary of Prior Art

The conventional wall type electrical receptacle and the male plug receptor of one end of electrical extension cord which normally called female connector generally have an insulate housing and a pair of transversely spaced electrical conductive contact bars and a grounded contact member for grounding purpose. The contact bars of such receptacle/connector generally parallel one another, and the flexible, slightly bowed flat bars are commonly used, wherefore suitable for the contact blades of the male plug be plugged in. Once the contact blades of the male plugs are inserted into the said housing, the flat bars or contact bars abut against the contact blades of the male plug, and the pressure of the flexed portions of the bars which frictionally retained the contact blades inside the said housing with some degree of intensity, but is not enough to prevent the disconnection between the male plug and the said receptacle/connector, therefore, such locking and releasable receptacles/connectors were well invented such as: U.S. Patent Nos. 5,893,772 to R. Carmo et al, 5,393,239 to N. E. Ursich, 4,909,749 to J. Long.

But these arrangements of prior inventions are costly and complex to produce and are not commonly used. The primary objective of this invention is to provide an electrical receptacle/connector having a locking and releasable function with simple, effective and low cost advantages. The present invention fulfills such a need.

### SUMMARY OF THE INVENTION

The purpose of the present invention is to provide a locking and releasable receptacle/connector for use with a standard electrical male plug, comprising of a housing of insulating material having an aperture end wall adapted to allow a pair of electrically conductive contact blades of an electrical plug to be inserted through there, the said housing having transversely spaced, electrically conductive resilient contact bars positioned and adapted to be contacted by the said contact blades to transmit the electricity. The said contact bar having well positioned, one directional lockable jut elements portion constructed and arranged to fit into the related holes of each said contact blades when the plug is fully inserted; wherefore to prevent the opposite movement of said plug. Upon the reception, the said plug is unable to be freed unless preferred. When the preference of separation of the said plug is considered necessary, a slide able nonconductive element being accessible from the outside of the said housing, engaged to release the said jut elements from the holes of the said contact blades of said plug, said slide able element means the locking release button, when depressed which deflect the jut element portion, causing the jut elements to swing out off the holes of the contact blades, disengage from the holes of contact blades of the male plug, therefore eliminating the locking function of the said jut elements. Since there is a minimal amount of moving parts, it lessens the chance of breakage, furthermore, it is more effective and more cost efficient to produce.

### BRIEF DESCRIPTION OF THE DRAWINGS

FIG. 1 is a perspective view of a male plug to be mated with a wall receptor constructed in accordance with this invention, with wall and cover plate omitted.

FIG. 2 is a perspective view of a male plug to be mated with a female connector of one end of the extension cord constructed in accordance with this invention.

FIG. 3 is a sectional plan view take along the line 3-3 of FIG. 1 and FIG. 2 showing the condition of the plug of contact blades of an electrical plug into it.

FIG. 4 is a sectional plan view take along the line 4-4 of FIG. 1 and FIG. 2 showing the condition of the plug contact blades has been inserted into it.

FIG. 5 is a partially perspective view of jut element on the contact bar as shown on FIG. 3.

FIG. 6 is a partially perspective view of another version of jut element on the contact bar.

FIG. 7 is a partially perspective view of another version of jut element on the contact bar.

FIG. 8 is a partially perspective view of another version of jut element on the contact bar.

FIG. 9 is a partially perspective view of another version of jut element on the contact bar.

FIG. 10 is a partially perspective view of another version of jut element on the contact bar.

FIG. 11 is a partially perspective view of another version of jut element on the contact bar with contact blade inserted condition.

FIG. 12 is a partially perspective view of another version of jut element on the contact bar with contact blade inserted condition

FIG. 13 is a partially perspective of another version of said invention.

### DETAILED DESCRIPTION

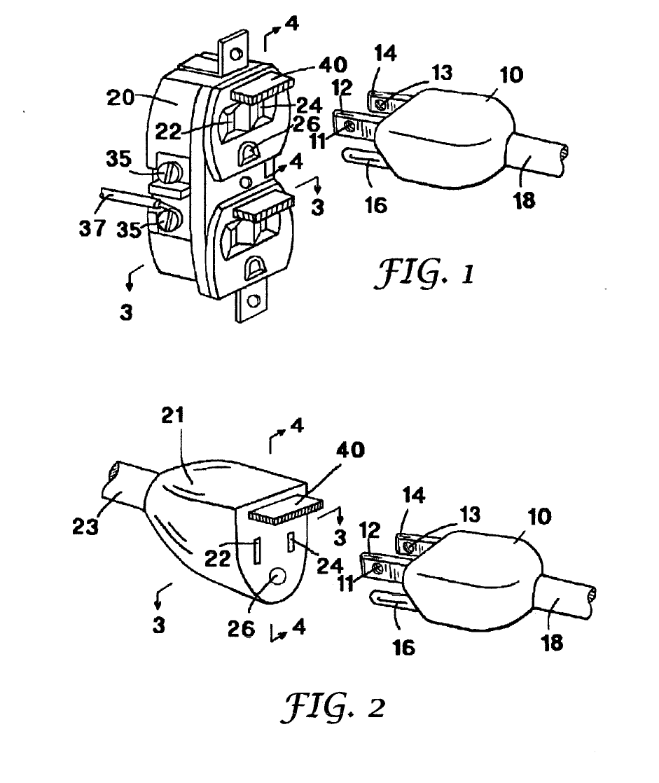

FIG. 1 shown a commonly used electrical duplex wall receptor, which having two similar receptors within one same housing 20, only one receptor will be described here.

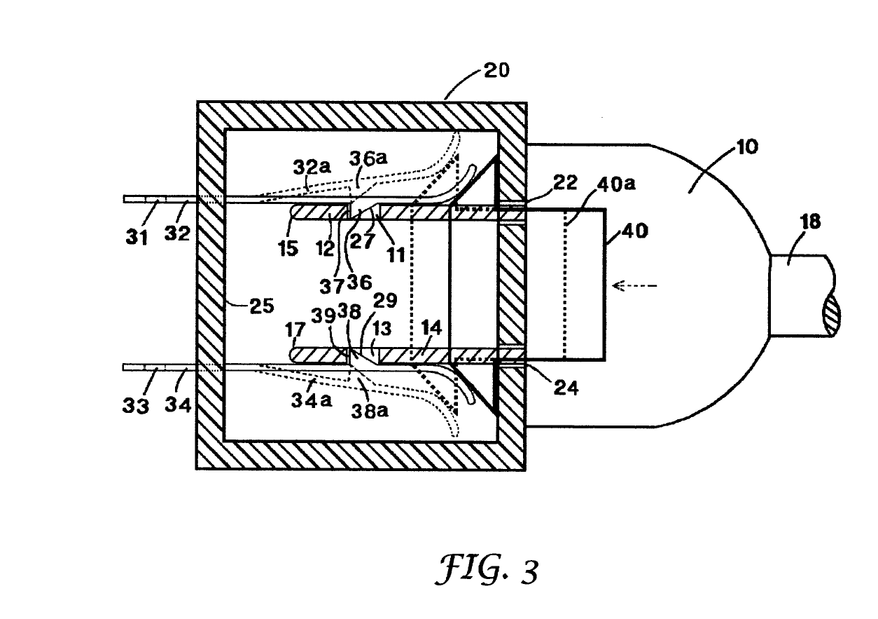

FIG. 2 shown a female connector of one end of conventional electrical extension cord 23;

FIG. 1 and FIG. 2, both constructed in accordance with the concepts of the invention, positioned to mate with a grounded male plug 10, where the receptacle/connector usually having a insulating housing 20 as wall receptor, 21 as female connector, which contains two transversely spaced resilient conductive bars adapted to contact to corresponding contact blades of the plug 10 through arranged opening 22, 24 to transmit the electricity, the third opening 26 has a contact conductor inside to accept the ground pin 16 of the plug 10 for ground purpose, and holes 11, 13 on the end of contact blades 12, 14 of said plug 10 is a must to perform the locking function of this invention; 18 is the wire connection for the plug 10, 23 is the wire connection for extension cord, screws 35 for tighten the wire 37 on the contact bar (not show in FIG. 1 and FIG. 2) to connect the electricity from power source.

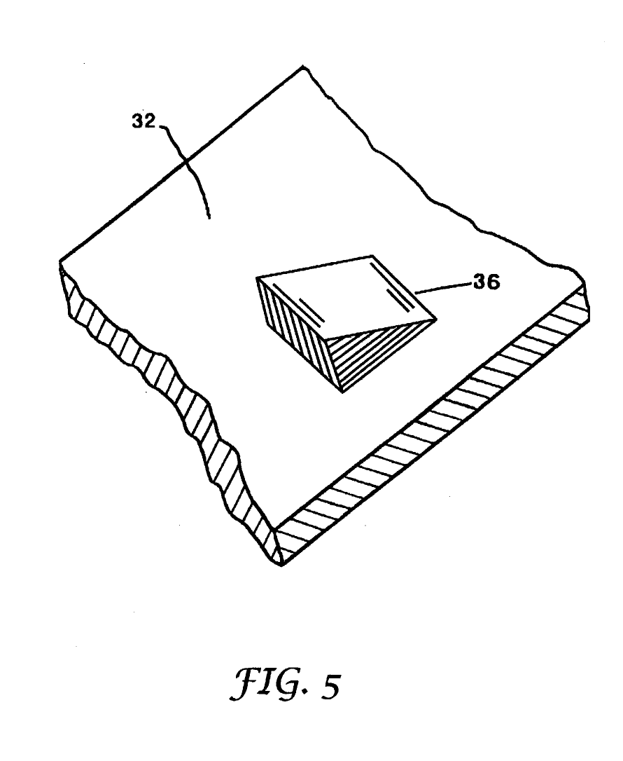

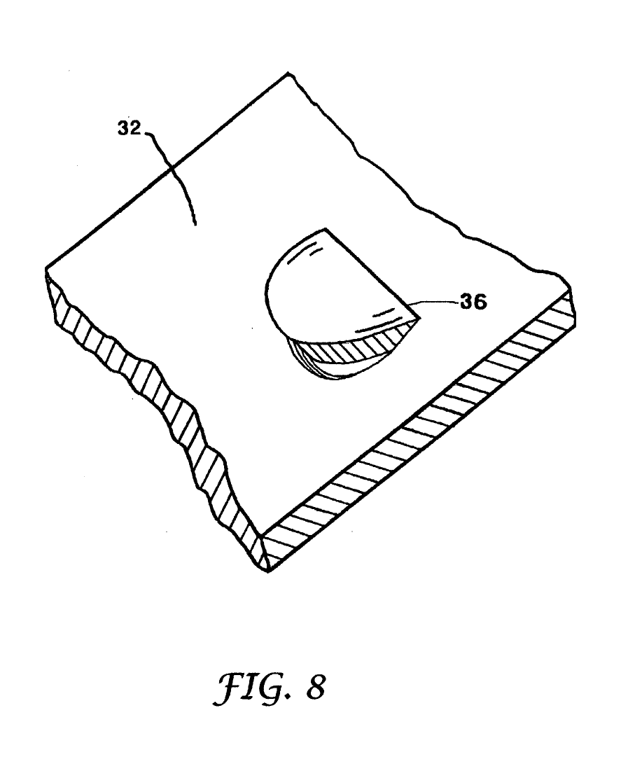

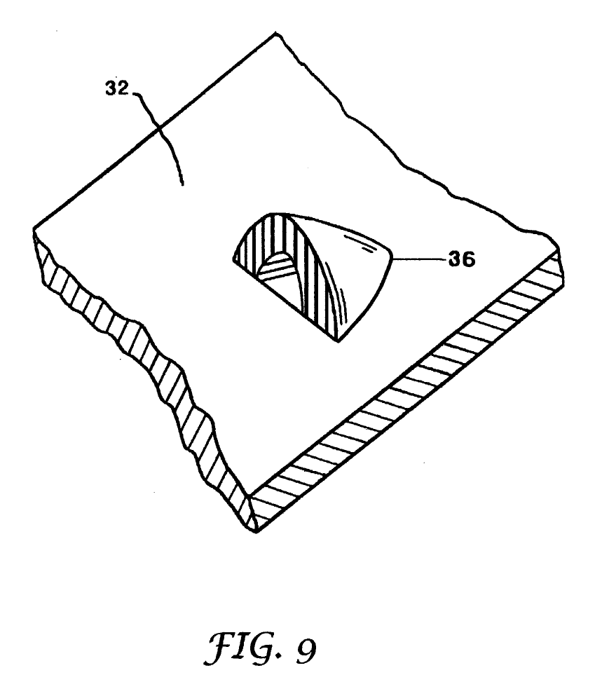

FIG. 3 shows inside of the said receptacle/connector, which contains two transversely spaced resilient conductive bars 32, 34 adapted to contact to corresponding contact blades 12, 14 of the plug 10 through arranged opening 22, 24 to transmit the electricity, 31, 33 are thread holes for screws 35 to tighten the wires 37 (35 & 37 was omitted in this drawing) on the contact bars 32, 34 to connect the electricity from power source, a locking release button 40 made with nonconductive material was arranged to be slid between released position, means actuated position 40a (phantom lines) and unreleased position means deactuated position 40 (solid lines), and access from outside housing 20 to be pushed (arrow direction) to release the contact blades 12, 14, when release is desired; and the resilient contact bars 32, 34 biased the said locking release button (phantom lines) 40a back to unreleased position (solid lines) 40, whenever the push force is removed. When the plug 10 mate with the said receptacle/connector, which is inserting said contact blades 12, 14 through the opening 22, 24 of the housing 20, the adapted resilient contact bars 32, 34 constructed inside the housing 20 arranged to allow the contact blades 12, 14 frictionally to be fully inserted and to contact related contact bars 32, 34 each other, once the contact blades 12, 14 is fully inserted, where both jut elements 36, 38 on each contact bars 32, 34 were positioned to bias into the holes 11, 13 of each contact blades 12, 14, the jut elements 36, 38 shaped like a half funnel as FIG. 9, a slope or other forms, a punch out of the same bars 32, 34 as FIG. 8, 9, 10 or a molded lump as FIGS. 5, 6, 7 was preferred, and the downward sloping portions 27, 29 is facing the openings 22, 24 of the housing 20 means the contact blades 12, 14 insert direction (arrow direction), which ensure the free end parts 15, 17 of the contact blades 12, 14 be slide over the jut elements 36, 38 of the said contact bars 32, 34 during insertion. With the contact blades 12, 14 fully inserted, the said jut elements 36, 38 on the resilient contact bars 32, 34 arranged bias into each related holes 11, 13; and the said jut elements 36, 38 having a sudden angular jutting portions 37, 39 face the opposite side 25 of said openings 22, 24, which stopped the said contact blades 12, 14 to move opposite directions as pull apart, once the said jut elements 36, 38 inside the holes 11, 13 of said contact blades 12, 14, meaning the contact blades 12, 14 is wedged and immobilized by the sudden angular portion of the said jut element within the holes 11, 13. The ground pin 16 of the plug 10 and contact conductor constructed inside the housing 20 were omitted for clarity. When separation is needed, means withdrawal of the plug 10 is desired, depress the locking release button 40 which slides in to push apart the said contact bars 32a, 34a (phantom lines), therefore swinging out the said jut elements 36a, 38a (phantom lines) off the holes 11, 13 of said contact blades 12, 14, which eliminates the locking function, therefore withdrawal can be made the same as non locking receptor/connector.

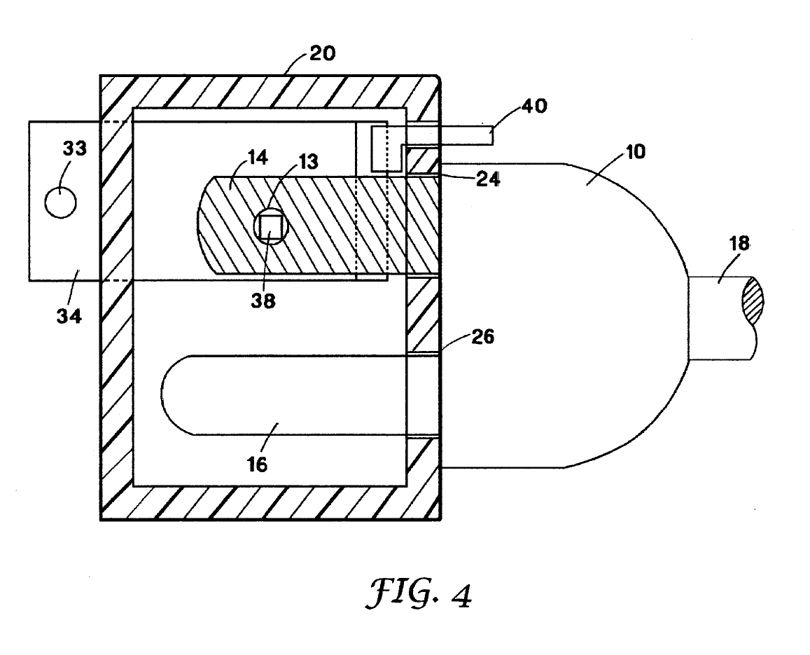

FIG. 4 is a side view of FIG. 3 with ground pin 16, but the contact conductor for pin 16 was omitted for clarity.

FIG. 5 shown with the jut element 36 on the partially contact bar 32 as shown on

FIG. 3 and FIG. 4 for more clear view.

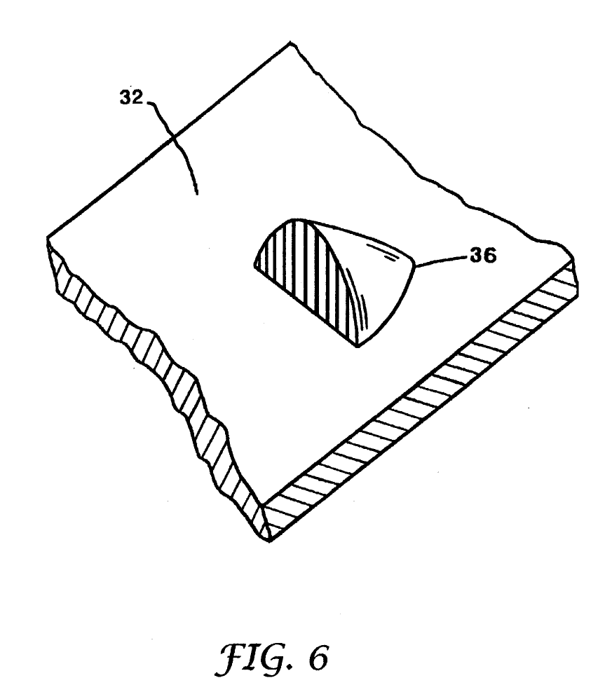

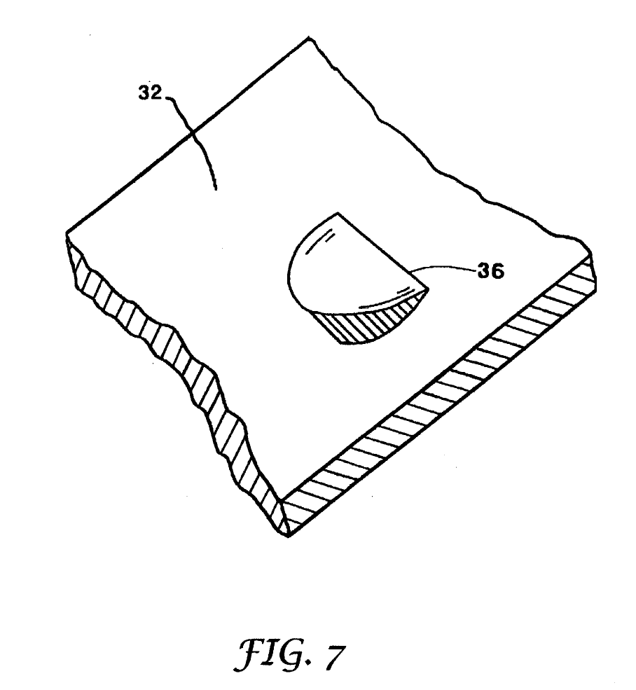

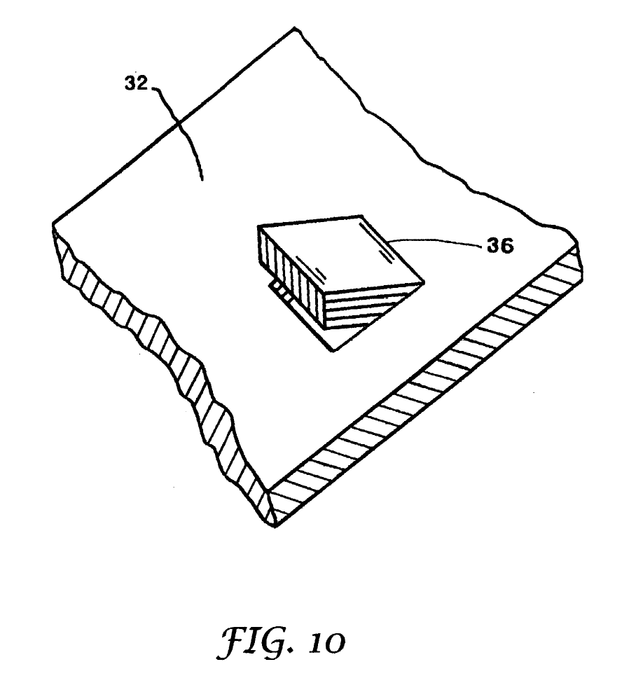

FIGS. 6-10 shown different versions of said jut element 36 on the partially contact bar 32, which enable the same function as above.

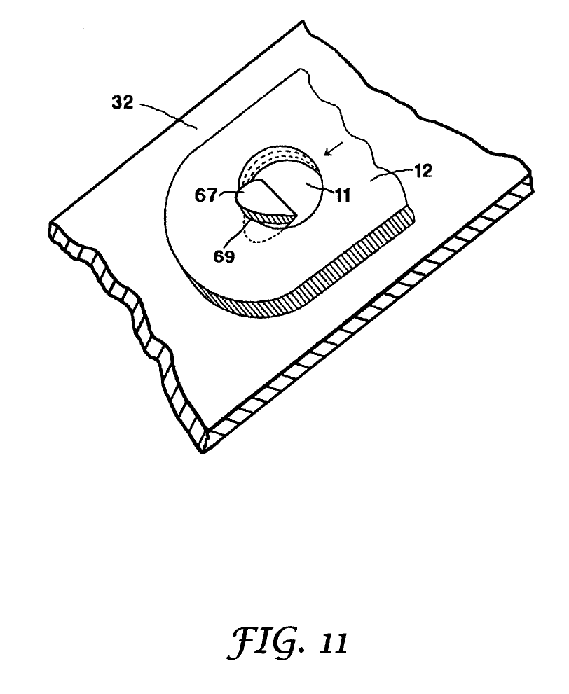

FIG. 11 shown one jut element 67 and partially contact bar 32 with partially contact blade 12 inserted condition and the jut element 67 was inside the hole 11 of the contact blade 12, the jut element 67 shaped like a hook, a stick out tongue, an overhang, or any other forms which with any separation force makes the contact blade 12, stay deeper inside of the hook 69 of said jut element 67 where the hole 11 is, which stopped the jut element 67 off the vertical movement, therefore withdrawal is impossible unless broken. When withdrawal is desired, first insert (arrow direction) the plug fully till stop, that arranges the contact blade 12 where the hole 11 is to pass the hook point 69, means the said jut element 67 enable it to be off the hole 11 with vertical movement, then push the locking release button 40, which slide away (similar as said vertical movement) the said jut element 67 off the hole 11 of said contact blade 12 therefore enable the plug 10 to be pull apart.

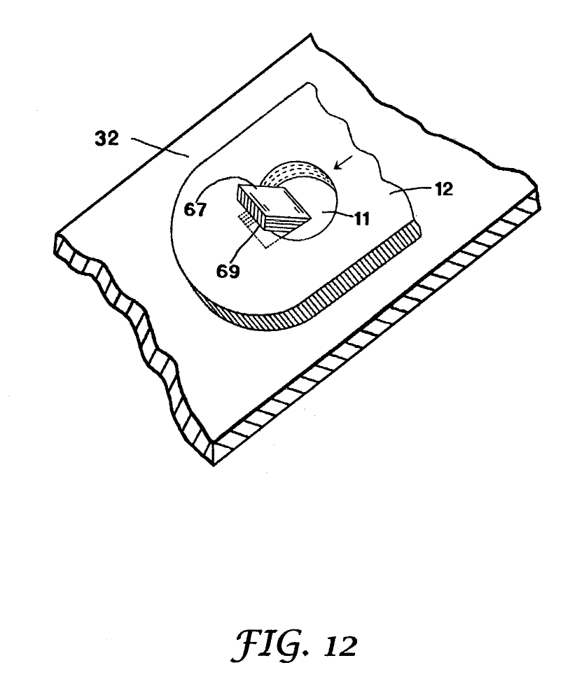

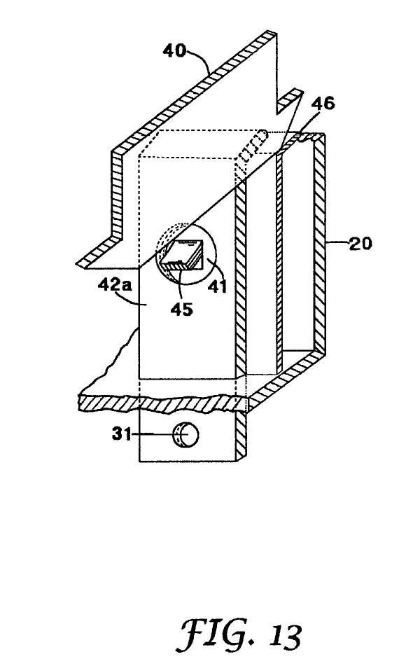

FIG. 12 is another version of FIG. 11 and it functions as same.

FIG. 13 Shows another version which the jut element 45 was constructed on a separate portion 46 from said contact bar 42a, and the contact bar 42a having a aperture 41, therein adapted to pass the said jut element 45 through; the said portion 46 may be made more resilient for easy to push to unlock the contact blade 12 (not shown here) of the plug 10, and the said portion 46 should be bigger than said contact bar 42a which can be pushed away by locking release button 40. The function is same as illustrated in FIG. 3 and FIG. 4 with the jut element 36 on the contact bar 32.

While there have been shown and described in its preferred embodiments of this invention, various modification and changes may be made without departing from the spirit and scope of the invention which is to be limited as defined in the appended claim.

What is claimed is:

1. The locking and releasable electrical receptacle/connector for receiving and withdrawing the prongs of a electrical male plug, said prong means the contact blade of the said plug; connecting and disconnecting the said receptacle/connector to transmit and cease electricity to a device. The locking function of said locking and releasable receptacle/connector only suitable for the said prongs of said plug each having a hole near its free end. Comprising in combination:
a. A body made with nonconductive housing having openings at one end for insertion of said prongs.
b. Said body having at least one resilient contact bar arranged for each said prongs to be in tact to transmit electricity.
c. At least one well positioned, one directional lockable jut element constructed in front of the contact surface of each said prongs, which actuate to engage into the related holes of each said prongs of said plug, wherein said plug insert direction, means fully inserted position; and reject to release from opposite direction, means refuse to dislodge the said plug, means prevent its withdrawal of said prongs of said plug from said receptacle/connector.
d. Said jut element having a downward sloping portion, means a slant downward portion, means enabling the said prongs to be slide over, which faces the opening of said body; and having an angular projection portion, means sudden jutting portion faces the other end of the opening of said body.
e. A locking release button engaged the movement of said jut element portions for said jut elements off the holes of the said prongs of the said plug to be freely to withdraw.

2. The locking and releasable electrical receptacle/connector for receiving and withdrawing the prongs of a electrical male plug, said prong means the contact blade of the said plug; connecting and disconnecting the said receptacle/connector to transmit and cease electricity to a device. The locking function of said locking and releasable receptacle/connector only suitable for the said prongs of said plug each having a hole near its free end. Comprising in combination:
a. A body made with nonconductive housing having openings at one end for insertion of said prongs.
b. Said body having at least one resilient contact bar arranged for each said prongs to be in tact to transmit electricity.
c. At least one well positioned, one directional lockable jut element constructed on the said resilient contact bar, which actuate to engage into the related hole of each said prongs of said plug, wherein said plug insert direction, means fully inserted position;
and reject to release from opposite direction, means refuse to dislodge the said plug, means prevent its withdrawal of said prongs of said plug from said receptacle/connector.
d. Said jut element having a downward sloping portion, means a slant downward portion, means enabling the said prongs to be slide over, which faces the opening of said body; and having an angular projection portion, means sudden jutting portion faces the other end of the opening of said body.
e. A locking release button mounted in said receptacle/connector body in operative relationship to said actuator means for selectively engaging the movement of said jut element portions for said jut elements off the holes of the said prongs of the said plug to be freely withdrawn.

3. The locking and releasable electrical receptacle/connector for receiving and withdrawing the prongs of a electrical male plug, said prong means the contact blade of the said plug; connecting and disconnecting the said receptacle/connector to transmit and cease electricity to a device. The locking function of said locking and releasable receptacle/connector only suitable for the said prongs of said plug each having a hole near its free end. Comprising in combination:
a. A body made with nonconductive housing having openings at one end for insertion of said prongs.
b. Said body having at least one resilient contact bar arranged for each said prongs to be in contact to transmit electricity.
c. At least one well positioned, one directional lockable jut element constructed on a separate portion from the said resilient contact bar, therein adapted to pass through the related aperture of said resilient contact bar, which actuate to engage into the related hole of each said prongs of said plug, wherein said plug insert direction, means fully inserted position; and reject to release from opposite direction, means refuse to dislodge the said plug, means prevent its withdrawal of said prongs of said plug from said receptacle/connector.
d. Said jut element shaped like a wedge, having a downward sloping portion, means a slant downward portion, means enabling the said prongs to be slide over, which faces the opening of said body; and having an angular projection portion, means sudden jutting portion faces the other end of the opening of said body.
e. A locking release button mounted in said receptacle/connector body in operative relationship to said actuator means for selectively engaging the movement of said jut element portions for said jut elements off the holes of the said prongs of the said plug to be freely withdrawn.

4. The locking and releasable electrical receptacle/connector, according to claim 2 wherein the said jut element shaped like a hook, a stick out tongue, which faces the opposite of the opening of the said housing, and having a downward sloping portion, means a slant downward portion, means enabling the said prongs to be slide over, which facing the opening of said body.

5. The locking and releasable electrical receptacle/connector, according to claim 3 wherein the said jut element shaped like a hook, a stick out tongue, or an overhang which faces the opposite of the opening of the said housing, and having a downward sloping portion, means a slant downward portion, means enabling the said prongs to be slide over, which facing the opening of said body.
